(19) United States
(12) Patent Application Publication
(10) Pub. No.: US 2014/0085247 A1
(43) Pub. Date: Mar. 27, 2014

(54) Force Sensing Using Dual-Layer Cover Glass with Gel Adhesive and Capacitive Sensing

(71) Applicant: APPLE INC., Cupertino, CA (US)

(72) Inventors: Omar Sze Leung, Palo Alto, CA (US); Jonah A. Harley, Los Gatos, CA (US); James E. Wright, San Jose, CA (US); Craig Christopher Leong, San Jose, CA (US); Kristina A. Babiarz, San Jose, CA (US)

(73) Assignee: Apple Inc., Cupertino, CA (US)

(21) Appl. No.: 13/624,855

(22) Filed: Sep. 21, 2012

(51) Int. Cl. G06F 3/044

(52) U.S. Cl. 345/174; 178/18.06

(57) ABSTRACT

A touch device including a force sensor disposed between capacitive sensing structures, so both touch and force sensing occur capacitively using device drivers in rows and columns. A dual-layer cover glass, with gel adhesive separating first and second CG layers, so capacitive sensing between the first and second CG layers can determine both touch locations and applied force. The first and second CG layers include a compressible material having a Poisson's ratio of less than approximately 0.48, the force sensor being embedded therein, or disposed between the first and second CG layers. Applied force is detected using capacitive detection of depression of the first CG layer. Depression is responsive to compressible features smaller than optical wavelengths, so those features are substantially invisible to users. Alternatively, the compressible features may be large enough to be seen by a user, but made substantially invisible through the use of a fluid or other element filling spaces between the features. Such a fluid may have an index of refraction equal to, or nearly equal to, the index of refraction of the compressible features.

### TECHNICAL FIELD

This application generally relates to force sensing in a touch device, by capacitive or other methods, and related matters.

### BACKGROUND

Touch devices generally provide for identification of positions where the user touches the device, including movement, gestures, and other effects of position detection. For a first example, touch devices can provide information to a computing system regarding user interaction with a graphical user interface (GUI), such as pointing to elements, reorienting or repositioning those elements, editing or typing, and other GUI features. For a second example, touch devices can provide information to a computing system suitable for a user to interact with an application program, such as relating to input or manipulation of animation, photographs, pictures, slide presentations, sound, text, other audiovisual elements, and otherwise.

It sometimes occurs that, when interfacing with a GUI, or with an application program, it would be advantageous for the user to be able to indicate an amount of force applied when manipulating, moving, pointing to, touching, or otherwise interacting with, a touch device. For example, it might be advantageous for the user to be able to manipulate a screen element or other object in a first way with a relatively lighter touch, or in a second way with a relatively more forceful or sharper touch. In one such case, a it might be advantageous if the user could move a screen element or other object with a relatively lighter touch, while the user could alternatively invoke or select that same screen element or other object with a relatively more forceful or sharper touch.

Each of these examples, as well as other possible considerations, can cause one or more difficulties for the touch device, at least in that inability to determine an amount of force applied by the user when contacting the touch device might cause a GUI or an application program to be unable to provide functions that would be advantageous. When such functions are called for, inability to provide those functions may subject the touch device to lesser capabilities, to the possible detriment of the effectiveness and value of the touch device. On the other hand, having the ability to provide those functions might provide the touch device with greater capabilities, to the possible advantage of the effectiveness and value of the touch device.

### SUMMARY

This application provides techniques, including circuits and designs, which can determine amounts of force applied, and changes in amounts of force applied, by the user when contacting a touch device (such as a touch pad or touch display). These techniques can be incorporated into devices using touch recognition, touch elements of a GUI, and touch input or manipulation in an application program. This application also provides techniques, including devices that apply those techniques, which can determine amounts of force applied, and changes in amounts of force applied, by the user when contacting a touch device, and in response thereto, provide additional functions available to a user of a touch device.

In one embodiment, techniques can include providing a force sensitive sensor incorporated into a touch device, and measuring deflection in the force sensitive sensor. For example, the force sensitive sensor can be disposed between capacitive sensing structures, with the effect that both capacitive sensing can be conducted in combination or conjunction with force sensing.

In one embodiment, a force sensitive sensor can include a dual-layer cover glass (CG), in which a gel adhesive separates a first CG layer and a second CG layer. Capacitive sensing between the first CG layer and the second CG layer can determine a touch location. A force sensitive structure between the first CG layer and the second CG layer can determine amounts of applied force at the same or a nearby location. This has the effect that amounts of force can be measured with respect to deformation of a distance between the first CG layer and the second CG layer.

In one embodiment, the gel adhesive can include a compressible material having a Poisson's ratio of less than approximately 0.48. The force sensitive structure can be embedded in the material, or can be disposed between the first CG layer and the second CG layer without necessarily being surrounded by the material. For example, the force sensitive structure can include a set of separate device drivers in row and column elements, disposed to detect applied force at force sensing elements, in parallel to the operation of capacitive sensing at touch sensing elements. For example, detection of applied force at force sensing elements can be conducted using capacitive detection of depression of the top CG layer.

In one embodiment, the force sensitive structure can include a set of features that are compressible even if the material is otherwise. This can have the effect that applied force, when applied to the top CG layer, can be detected by compressibility of those features of the force sensitive structure. In one embodiment, the force sensitive structure includes compressible features smaller than optical wavelengths. This can have the effect that those features are substantially transparent, or otherwise not apparent to a user of the device. For example, those features can include “moth eye” elements (such as including nanostructured pyramids, pillars, cones, or other elongated nanoscale elements), nanopore elements, foam elements, micro-structured silicone elements, or otherwise. For example, those features could include one or more of: a set of individual relatively open elements; a set of relatively compressible solid elements; a network of both open areas and solid elements, such as an interpenetrating network thereof; a combination or conjunction of regions which include relatively open areas and regions which include relatively solid elements; or otherwise. These features can be formed from any suitable material, including (but not limited to) silicone, other compressible elastomers, acrylic, and the like.

In one embodiment, those features can include silicone elements that are disposed in pyramidal structures, with the effect that they provide a substantially linear capacitive sensor during compression of a distance between the first CG layer and the second CG layer. Such structures can provide a stiffness that is proportional to a square of their dimension. In similar embodiments, the silicone elements can be disposed in “pyramidal lines”, that is, structures that are pyramidal along a first dimension and linear along a second dimension, with the effect of providing an element with linear length and with pyramidal width. Such structures can provide a stiffness that is linear in their width, and can operate as strain gauges to measure applied force. In similar embodiments, those features can include silicone elements in substantially other shapes, including cylinders, spring structures, and including inverted versions of the described shapes, and otherwise.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims particularly pointing out and distinctly claiming the subject matter that is regarded as forming the present disclosure, it is believed that the disclosure will be better understood from the following description taken in conjunction with the accompanying Figures, in which:

FIG. 1 shows a conceptual drawing of communication between a touch I/O device and a computing system.

FIG. 2 shows a conceptual drawing of a system including a force sensitive touch device.

FIG. 3 shows a conceptual drawing of a force sensor including a dual-layer cover glass.

FIG. 4 shows a conceptual drawing of a circuit including a touch sensor and a force sensor.

FIGS. 5A-D show conceptual drawings of force sensitive structures.

### DETAILED DESCRIPTION

### Terminology

The following terminology is exemplary, and not intended to be limiting in any way.

The text “applied force”, and variants thereof, generally refers to a degree or measure of an amount of force being applied to a device. The degree or measure of applied force need not have any particular scale. For example, the measure of applied force can be linear, logarithmic, or otherwise nonlinear, and can be adjusted periodically (or otherwise, such as aperiodically, or otherwise from time to time) in response to one or more factors, either relating to applied force, location of touch, time, or otherwise.

The text “force sensing element”, and variants thereof, generally refers to one or more data elements of any kind, including information sensed with respect to applied force, whether at individual locations or otherwise. For example and without limitation, a force sensing element can include data or other information with respect to a relatively small region of where a user is forcibly contacting a device.

The text “touch sensing element”, and variants thereof, generally refers to one or more data elements of any kind, including information sensed with respect to individual locations. For example and without limitation, a touch sensing element can include data or other information with respect to a relatively small region of where a user is contacting a touch device.

The text “user's finger”, and variants thereof, generally refers to a user's finger, or other body part, or a stylus or other device, such as when used by a user to apply force to a touch device, or to touch a touch device. For example and without limitation, a “user's finger” can include any part of the user's finger, the user's hand, a covering on the user's finger, a soft or hard stylus, a light pen or air brush, or any other device used for pointing, touching, or applying force to, a touch device or a surface thereof.

After reading this application, those skilled in the art would recognize that these statements of terminology would be applicable to techniques, methods, physical elements, and systems (whether currently known or otherwise), including extensions thereof inferred or inferable by those skilled in the art after reading this application.

Force Sensitive Device and System

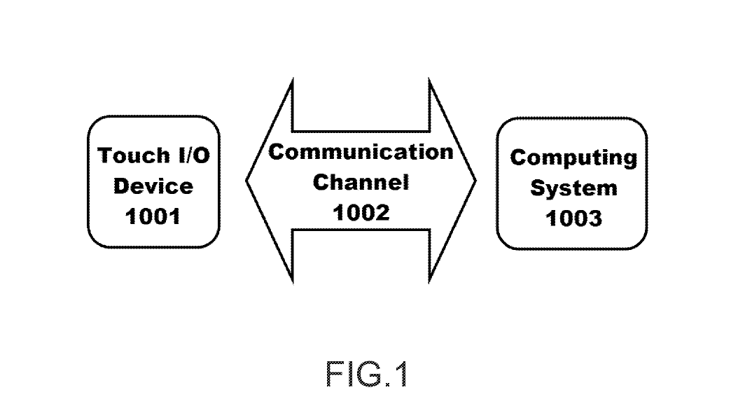

FIG. 1 shows a conceptual drawing of communication between a touch I/O device and a computing system.

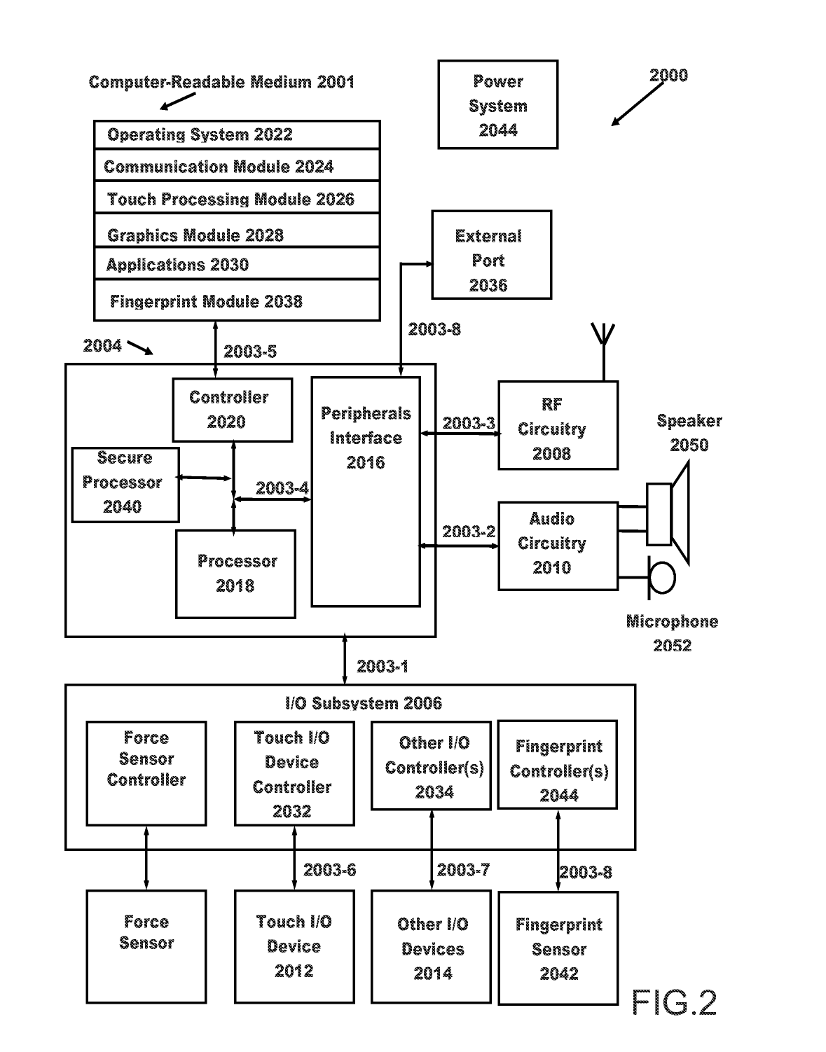

FIG. 2 shows a conceptual drawing of a system including a force sensitive touch device.

Described embodiments may include touch I/O device 1001 that can receive touch input and force input (such as possibly including touch locations and applied force at those locations) for interacting with computing system 1003 (such as shown in the FIG. 1) via wired or wireless communication channel 1002. Touch I/O device 1001 may be used to provide user input to computing system 1003 in lieu of or in combination with other input devices such as a keyboard, mouse, or possibly other devices. In alternative embodiments, touch I/O device 1001 may be used in conjunction with other input devices, such as in addition to or in lieu of a mouse, trackpad, or possibly another pointing device. One or more touch I/O devices 1001 may be used for providing user input to computing system 1003. Touch I/O device 1001 may be an integral part of computing system 1003 (e.g., touch screen on a laptop) or may be separate from computing system 1003.

Touch I/O device 1001 may include a touch sensitive and force sensitive panel which is wholly or partially transparent, semitransparent, non-transparent, opaque or any combination thereof. Touch I/O device 1001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard, disposed on a trackpad or other pointing device), any multi-dimensional object having a touch sensitive surface for receiving touch input, or another type of input device or input/output device.

In one example, touch I/O device 1001 embodied as a touch screen may include a transparent and/or semitransparent touch sensitive and force sensitive panel at least partially or wholly positioned over at least a portion of a display. (Although the touch sensitive and force sensitive panel is described as at least partially or wholly positioned over at least a portion of a display, in alternative embodiments, at least a portion of circuitry or other elements used in embodiments of the touch sensitive and force sensitive panel may be at least positioned partially or wholly positioned under at least a portion of a display, interleaved with circuits used with at least a portion of a display, or otherwise.) According to this embodiment, touch I/O device 1001 functions to display graphical data transmitted from computing system 1003 (and/or another source) and also functions to receive user input. In other embodiments, touch I/O device 1001 may be embodied as an integrated touch screen where touch sensitive and force sensitive components/devices are integral with display components/devices. In still other embodiments a touch screen may be used as a supplemental or additional display screen for displaying supplemental or the same graphical data as a primary display and to receive touch input, including possibly touch locations and applied force at those locations.

Touch I/O device 1001 may be configured to detect the location of one or more touches or near touches on device 1001, and where applicable, force of those touches, based on capacitive, resistive, optical, acoustic, inductive, mechanical, chemical, or electromagnetic measurements, in lieu of or in combination or conjunction with any phenomena that can be measured with respect to the occurrences of the one or more touches or near touches, and where applicable, force of those touches, in proximity to device 1001. Software, hardware, firmware or any combination thereof may be used to process the measurements of the detected touches, and where applicable, force of those touches, to identify and track one or more gestures. A gesture may correspond to stationary or non-stationary, single or multiple, touches or near touches, and where applicable, force of those touches, on touch I/O device 1001. A gesture may be performed by moving one or more fingers or other objects in a particular manner on touch I/O device 1001 such as tapping, pressing, rocking, scrubbing, twisting, changing orientation, pressing with varying pressure and the like at essentially the same time, contiguously, consecutively, or otherwise. A gesture may be characterized by, but is not limited to a pinching, sliding, swiping, rotating, flexing, dragging, tapping, pushing and/or releasing, or other motion between or with any other finger or fingers, or any other portion of the body or other object. A single gesture may be performed with one or more hands, or any other portion of the body or other object by one or more users, or any combination thereof.

Computing system 1003 may drive a display with graphical data to display a graphical user interface (GUI). The GUI may be configured to receive touch input, and where applicable, force of that touch input, via touch I/O device 1001. Embodied as a touch screen, touch I/O device 1001 may display the GUI. Alternatively, the GUI may be displayed on a display separate from touch I/O device 1001. The GUI may include graphical elements displayed at particular locations within the interface. Graphical elements may include but are not limited to a variety of displayed virtual input devices including virtual scroll wheels, a virtual keyboard, virtual knobs or dials, virtual buttons, virtual levers, any virtual UI, and the like. A user may perform gestures at one or more particular locations on touch I/O device 1001 which may be associated with the graphical elements of the GUI. In other embodiments, the user may perform gestures at one or more locations that are independent of the locations of graphical elements of the GUI. Gestures performed on touch I/O device 1001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within computing system 1003 (e.g., affect a state or mode of a GUI, application, or operating system). Gestures may or may not be performed on touch I/O device 1001 in conjunction with a displayed cursor. For instance, in the case in which gestures are performed on a touchpad, a cursor (or pointer) may be displayed on a display screen or touch screen and the cursor may be controlled via touch input, and where applicable, force of that touch input, on the touchpad to interact with graphical objects on the display screen. In other embodiments in which gestures are performed directly on a touch screen, a user may interact directly with objects on the touch screen, with or without a cursor or pointer being displayed on the touch screen.

Feedback may be provided to the user via communication channel 1002 in response to or based on the touch or near touches, and where applicable, force of those touches, on touch I/O device 1001. Feedback may be transmitted optically, mechanically, electrically, olfactory, acoustically, haptically, or the like or any combination thereof and in a variable or non-variable manner.

Attention is now directed towards embodiments of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other (portable or non-portable) system or device adaptable to the inclusion of system architecture 2000, including combinations of two or more of these types of devices. Figure Y is a block diagram of one embodiment of system 2000 that generally includes one or more computer-readable mediums 2001, processing system 2004, Input/Output (I/O) subsystem 2006, electromagnetic frequency circuitry, such as possibly radio frequency (RF) or other frequency circuitry 2008 and audio circuitry 2010. These components may be coupled by one or more communication buses or signal lines 2003. Each such bus or signal line may be denoted in the form 2003-X, where X can be a unique number. The bus or signal line may carry data of the appropriate type between components; each bus or signal line may differ from other buses/lines, but may perform generally similar operations.

It should be apparent that the architecture shown in FIGS. 1-2 is only one example architecture of system 2000, and that system 2000 could have more or fewer components than shown, or a different configuration of components. The various components shown in FIGS. 1-2 can be implemented in hardware, software, firmware or any combination thereof, including one or more signal processing and/or application specific integrated circuits.

RF circuitry 2008 is used to send and receive information over a wireless link or network to one or more other devices and includes well-known circuitry for performing this function. RF circuitry 2008 and audio circuitry 2010 are coupled to processing system 2004 via peripherals interface 2016. Interface 2016 includes various known components for establishing and maintaining communication between peripherals and processing system 2004. Audio circuitry 2010 is coupled to audio speaker 2050 and microphone 2052 and includes known circuitry for processing voice signals received from interface 2016 to enable a user to communicate in real-time with other users. In some embodiments, audio circuitry 2010 includes a headphone jack (not shown).

Peripherals interface 2016 couples the input and output peripherals of the system to processor 2018 and computer-readable medium 2001. One or more processors 2018 communicate with one or more computer-readable mediums 2001 via controller 2020. Computer-readable medium 2001 can be any device or medium that can store code and/or data for use by one or more processors 2018. Medium 2001 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 2001 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processors 2018 run various software components stored in medium 2001 to perform various functions for system 2000. In some embodiments, the software components include operating system 2022, communication module (or set of instructions) 2024, touch and applied force processing module (or set of instructions) 2026, graphics module (or set of instructions) 2028, one or more applications (or set of instructions) 2030, and fingerprint sensing module (or set of instructions) 2038. Each of these modules and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise rearranged in various embodiments. In some embodiments, medium 2001 may store a subset of the modules and data structures identified above. Furthermore, medium 2001 may store additional modules and data structures not described above.

Operating system 2022 includes various procedures, sets of instructions, software components and/or drivers for controlling and managing general system tasks (e.g., memory management, storage device control, power management, etc.) and facilitates communication between various hardware and software components.

Communication module 2024 facilitates communication with other devices over one or more external ports 2036 or via RF circuitry 2008 and includes various software components for handling data received from RF circuitry 2008 and/or external port 2036.

Graphics module 2028 includes various known software components for rendering, animating and displaying graphical objects on a display surface. In embodiments in which touch I/O device 2012 is a touch sensitive and force sensitive display (e.g., touch screen), graphics module 2028 includes components for rendering, displaying, and animating objects on the touch sensitive and force sensitive display.

One or more applications 2030 can include any applications installed on system 2000, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system, also sometimes referred to herein as “GPS”), a music player, and otherwise.

Touch and applied force processing module 2026 includes various software components for performing various tasks associated with touch I/O device 2012 including but not limited to receiving and processing touch input and applied force input received from I/O device 2012 via touch I/O device controller 2032.

System 2000 may further include fingerprint sensing module 2038 for performing the method/functions as described herein in connection with other figures shown and described herein.

I/O subsystem 2006 is coupled to touch I/O device 2012 and one or more other I/O devices 2014 for controlling or performing various functions. Touch I/O device 2012 communicates with processing system 2004 via touch I/O device controller 2032, which includes various components for processing user touch input and applied force input (e.g., scanning hardware). One or more other input controllers 2034 receives/sends electrical signals from/to other I/O devices 2014. Other I/O devices 2014 may include physical buttons, dials, slider switches, sticks, keyboards, touch pads, additional display screens, or any combination thereof.

If embodied as a touch screen, touch I/O device 2012 displays visual output to the user in a GUI. The visual output may include text, graphics, video, and any combination thereof. Some or all of the visual output may correspond to user-interface objects. Touch I/O device 2012 forms a touch-sensitive and force-sensitive surface that accepts touch input and applied force input from the user. Touch I/O device 2012 and touch screen controller 2032 (along with any associated modules and/or sets of instructions in medium 2001) detects and tracks touches or near touches, and where applicable, force of those touches (and any movement or release of the touch, and any change in the force of the touch) on touch I/O device 2012 and converts the detected touch input and applied force input into interaction with graphical objects, such as one or more user-interface objects. In the case in which device 2012 is embodied as a touch screen, the user can directly interact with graphical objects that are displayed on the touch screen. Alternatively, in the case in which device 2012 is embodied as a touch device other than a touch screen (e.g., a touch pad or trackpad), the user may indirectly interact with graphical objects that are displayed on a separate display screen embodied as I/O device 2014.

Touch I/O device 2012 may be analogous to the multi-touch sensitive surface described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference.

Embodiments in which touch I/O device 2012 is a touch screen, the touch screen may use LCD (liquid crystal display) technology, LPD (light emitting polymer display) technology, OLED (organic LED), or OEL (organic electro luminescence), although other display technologies may be used in other embodiments.

Feedback may be provided by touch I/O device 2012 based on the user's touch, and applied force, input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 2000 also includes power system 2044 for powering the various hardware components and may include a power management system, one or more power sources, a recharging system, a power failure detection circuit, a power converter or inverter, a power status indicator and any other components typically associated with the generation, management and distribution of power in portable devices.

In some embodiments, peripherals interface 2016, one or more processors 2018, and memory controller 2020 may be implemented on a single chip, such as processing system 2004. In some other embodiments, they may be implemented on separate chips.

Further System Elements

In one embodiment, an example system includes a force sensor coupled to the touch I/O device 2012, such as coupled to a force sensor controller. For example, the force sensor controller can be included in the I/O subsystem 2006. The force sensor controller can be coupled to a processor or other computing device, such as the processor 2018 or the secure processor 2040, with the effect that information from the force sensor controller can be measured, calculated, computed, or otherwise manipulated. In one embodiment, the force sensor can make use of one or more processors or other computing devices, coupled to or accessible to the touch I/O device 2012, such as the processor 2018, the secure processor 2040, or otherwise. In alternative embodiments, the force sensor can make use of one or more analog circuits or other specialized circuits, coupled to or accessible to the touch I/O device 2012, such as might be coupled to the I/O subsystem 2006.

In one embodiment, as described below, the force sensor determines a measure of applied force from a user contacting the touch I/O device 2012. When the user applied force to the force sensor, the cover glass deforms in response to the applied force, pressing a first cover glass (CG) layer toward a second CG layer, and compressing a gel adhesive layer in between the two. This has the effect that a capacitive sensor can determine an amount of deformation of the first CG layer with respect to the second CG layer, thus the amount of applied force which caused that deformation. Although reference is made herein to “cover glass,” it should be appreciated that the covering element may be any suitable optically-transparent (or near-transparent) material. In some embodiments, sapphire and/or polycarbonate may be used as a covering element. Accordingly, references to a “cover glass” herein are meant to encompass other covering elements, including both sapphire and polycarbonate.

Example Force Sensor

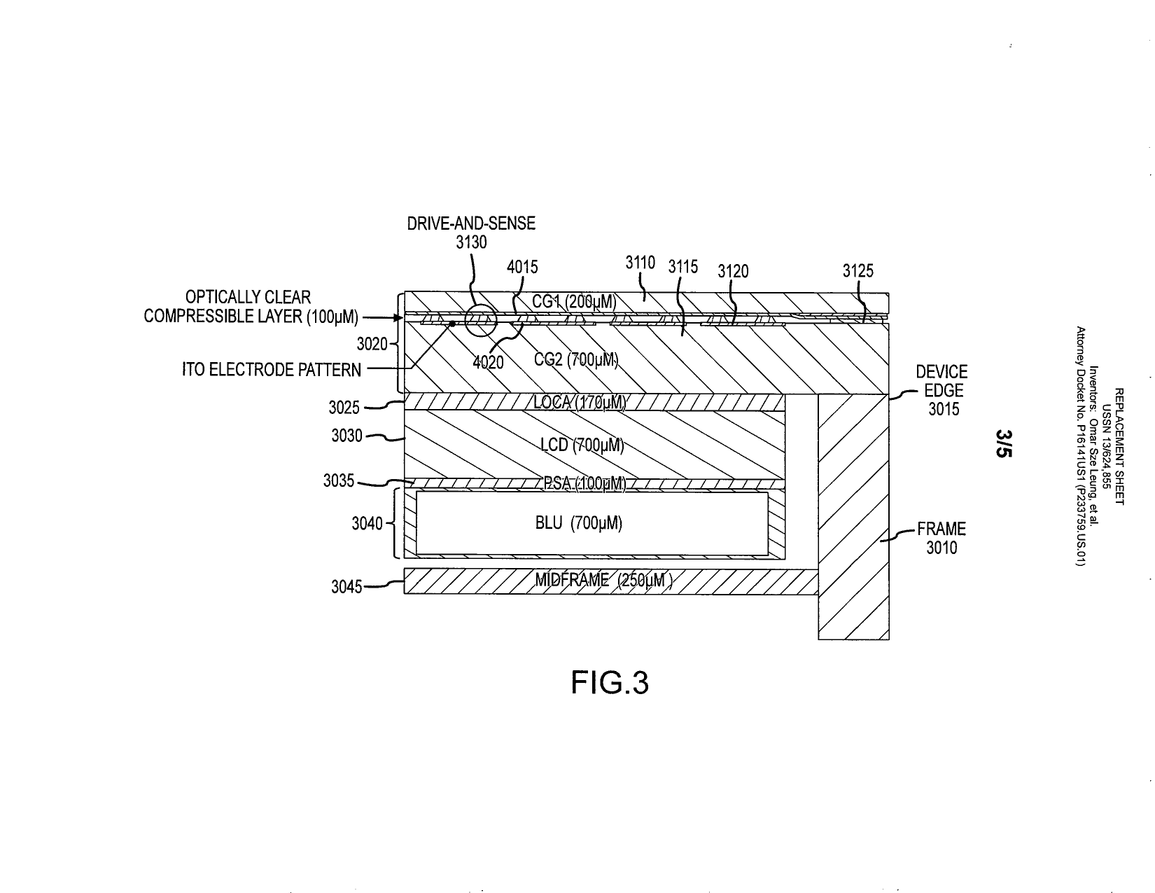

FIG. 3 shows a first conceptual drawing of a force sensor including a dual-layer cover glass.

The touch I/O device 2012 includes a frame 3010 and a device stack coupled to the frame 3010. The frame 3010 includes a device edge 3015, which is relatively solid and capable of supporting the device stack. The device stack includes a dual-layer cover glass (CG) construct 3020, a liquid optically clear adhesive (LOCA) layer 3025 positioned below the dual-layer CG construct 3020, a liquid crystal diode (LCD) layer 3030 positioned below the LOCA layer 3025, a pressure-sensitive adhesive (PSA) layer 3035 positioned below the LCD layer 3030, other layers 3040, and a midframe 3045.

In one embodiment, the liquid optically clear adhesive (LOCA) layer 3025 can have a thickness of approximately 170 microns. In one embodiment, the liquid crystal diode (LCD) layer 3030 can have a thickness of approximately 700 microns. In one embodiment, the pressure-sensitive adhesive (PSA) layer 3035 can have a thickness of approximately 100 microns. In one embodiment, other layers can have thickness values appropriate to their particular functions.

The dual-layer CG construct 3020 includes a first CG layer 3110, a second CG layer 3115 positioned below the first CG layer 3110, a compressible layer 3120 positioned between the first CG layer 3110 and the second CG layer 3115, and a separator 3125 positioned between the first CG layer 3110 and the second CG layer 3115. In one embodiment, the separator 3125 is coupled to the frame 3010, and is disposed around a region of the dual-layer CG construct 3020 so that the dual-layer CG construct 3020 can be deformed while being supported by the frame 3010. The dual-layer CG construct also can include a drive-and-sense construct 3130, which provides for force detection and for touch detection, as described below.

In one embodiment, when the user applies force to the dual-layer CG construct 3020, the first CG layer 3110 is deformed and pressed downward toward the second CG layer 3115, compressing the compressible layer 3120 positioned in between and causing the drive-and-sense construct 3130 to operate. The drive-and-sense construct 3130 operates in response to applied force on the first CG layer 3110, and in response to touch on the first CG layer 3110. This provides information to the touch I/O device 2012 that allows the latter to determine an amount of applied force and a location of applied force, and a location of touch, by the user's finger.

In one embodiment, the first CG layer 3110 can have a thickness of approximately 200 microns. In one embodiment, the second CG layer 3115 can have a thickness of approximately 700 microns. In one embodiment, the compressible layer 3120 and the separator 3125 can each have a thickness of approximately 100 microns. In one embodiment, the drive-and-sense construct 3130 can be deposited using indium tin oxide (ITO) and can have a relatively small thickness. In one embodiment, other layers can have thickness values appropriate to their particular functions. The drive and sense construct may be made from any other suitable material, including silver nanowire, and other transparent conductive electrodes.

In one embodiment, as described below, the drive-and-sense construct 3130 operates using capacitive sensing. In a first mode, the drive-and-sense construct 3130 performs capacitive sensing to determine a touch location. In a second mode, the drive-and-sense construct 3130 performs capacitive sensing to determine an amount of applied force, and a location of applied force.

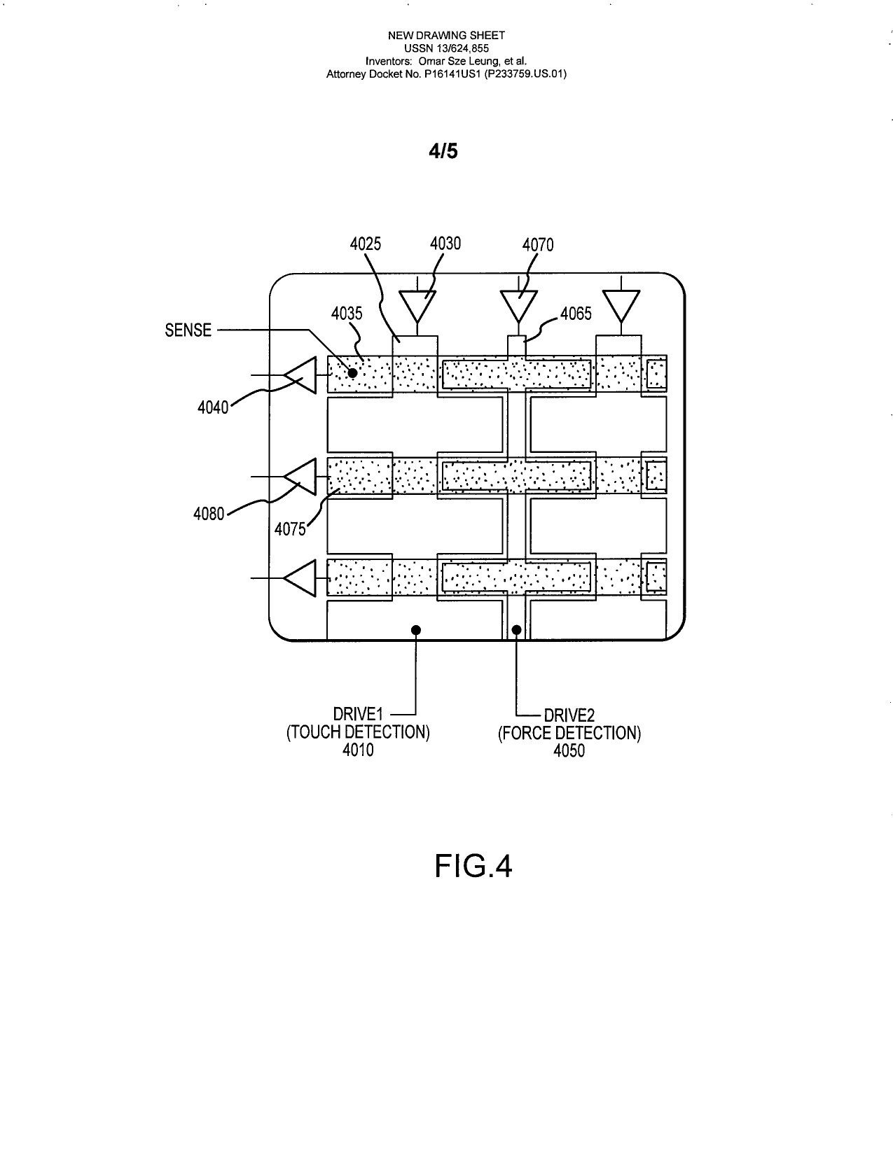

FIG. 4 shows a conceptual drawing of a circuit including a touch sensor and a force sensor.

TOUCH SENSOR. In one embodiment, the drive-and-sense construct 3130 can include a touch circuit 4010 including a first (drive) layer 4015 and a second (sense) layer 4020. For example, the drive layer 4015 can include an array of drive columns 4025, arranged row-wise so as to cover the entire cover glass, and each of which can be driven by a drive signal from an input circuit 4030. Similarly, the sense layer 4020 can include an array of sensor rows 4035, arranged column-wise so as to cover the entire cover glass, and each of which can sense a signal and be coupled to an output circuit 4040. The configuration illustrated in FIG. 4 generally shows the sense layer on top (e.g., nearer the viewer in the layout of the figure) and the drive layers, both force and touch, beneath the sense layer. It should be appreciated that alternative embodiments may place the drive layer(s) atop the sense layers, again with reference to the view of FIG. 4. IN such embodiments, the sense lines may be columns and the drive lines may be rows. In still other embodiments, the drive lines may be a repeating diamond-shaped pattern, such that adjacent touch and force sensing lines form an interlocking or near-interlocking configuration.

In one embodiment, the drive columns 4025 may be adjacent to the sensor rows 4035 at a set of relatively small elements; these adjacent areas may sometimes referred to herein as touch sensing elements. Each touch sensing element can provide an indicator of whether the cover glass has been touched at the particular location of that touch sensing element. For example, each drive column 4025 can be triggered by a drive signal from its corresponding input circuit 4030 at a selected time. For example, the drive columns 4025 can be triggered by their corresponding drive signals in a round-robin fashion, with the effect that each drive column 4025 is triggered substantially periodically.

When a drive column 4025 is triggered, the sense row 4035 that intersects that drive column 4025 at a particular touch sensing element can receive a signal if that particular touch sensing element is in fact being touched. For example, whether that particular touch sensing element is in fact being touched can be determined in response to a capacitance change due to the presence of the user's finger. This has the effect that the sense row 4035 is triggered at a time corresponding to the particular touch sensing element, when and if that particular touch sensing element is in fact being touched.

While this application primarily describes a system using dual-plate capacitive sensing, in the context of the invention, there is no particular requirement for any such limitation. For example, touch sensing can be performed using self capacitance instead of the illustrated mutual capacitance arrangement, in which the user's finger alters the coupling capacitance between a drive column 4025 and a sense row 4035.

FORCE SENSOR. In one embodiment, the drive-and-sense construct 3130 can also include a force circuit 4050 include a first (drive) layer 4055 and a second (sense) layer 4060, similar to the touch circuit 4010. For example, the drive layer 4055 can include an array of drive columns 4065, arranged row-wise so as to cover the entire cover glass, and each of which can be driven by a drive signal from an input circuit 4070. Similarly, the sense layer 4060 can include an array of sensor rows 4075, arranged column-wise so as to cover the entire cover glass, and each of which can sense a signal and be coupled to an output circuit 4080.

Similar to the touch sensor, in one embodiment, the drive columns 4065 can intersect the sensor rows at a set of relatively small elements, sometimes referred to herein as force sensing elements. Each force sensing element can provide an indicator of whether force has been applied to the cover glass at the particular location of that force sensing element. For example, whether that force sensing element has force being applied to it can be determined in response to a capacitance change due to deformation of the first CG layer 3110 with respect to the second CG layer 3115. Similarly, an amount of force being applied to that force sensing element can be determined in response to a capacitance change due to an amount of deformation of the first CG layer 3110 with respect to the second CG layer 3115.

Similar to the touch sensor, each drive column 4065 can be triggered by a drive signal from its corresponding input circuit 4070 at a selected time. For example, the drive columns 4065 can be triggered by their corresponding drive signals in a round-robin fashion, with the effect that each drive column 4065 is triggered substantially periodically.

Similar to the touch sensor, when a drive column 4065 is triggered, the sense row 4075 that intersects that drive column 4065 at a particular force sensing element can receive a signal if that particular force sensing element is in fact having force applied to it. Moreover, the amount of signal received (as measured by voltage, current, or otherwise) is responsive to an amount of force applied to that particular force sensing element. Also similar to the touch sensor, whether that particular force sensing element is in fact having force applied to it can be determined in response to a capacitance change due to the presence of the user's finger. Moreover, the amount of the capacitance change is responsive to an amount of force applied to that particular force sensing element.

Similar to the touch sensor, while this application primarily describes a system using dual-plate capacitive sensing, in the context of the invention, there is no particular requirement for any such limitation. For example, force sensing can be performed using self capacitance. In a self-capacitance system, the sensing electrode may be grounded, so that the capacitance between the force sense electrode and ground varies, thereby providing an estimate or measurement of force.

In one embodiment, the drive-and-sense construct 3130 operates when the user's finger causes the first CG layer 3110 to be deformed and pressed downward toward the second CG layer 3115, compressing the compressible layer 3120 positioned in between.

INTERLEAVED SENSORS. In one embodiment, the touch sensor and the force sensor can be interleaved, so that they are both positioned in between the first CG layer 3110 and the second CG layer 3115. For example, the drive columns 4025 for the touch sensor and the drive columns 4065 for the force sensor can be interleaved. When a circuit like this is constructed, the drive columns 4025 for the touch sensor and the drive columns 4065 for the force sensor can also be interleaved in the time they are triggered, with the effect that one or more drive columns 4025 for the touch sensor are triggered, followed by one or more drive columns 4065 for the force sensor being triggered, so that all drive columns for both the touch sensor and the force sensor are triggered in a round-robin fashion.

When the drive columns 4025 for the touch sensor and the drive columns 4065 for the force sensor are interleaved, those drive columns for both the touch sensor and the force sensor can also be coupled to a single set of sense rows 4075 for the touch sensor and the force sensor. This would have the effect that when a drive column 4025 for the touch sensor is triggered, the output signal would be responsive to whether the associated touch sensing element is being touched. Similarly, this would have the effect that when a drive column 4065 for the force sensor is triggered, the output signal would be responsive to whether the associated force sensing element is having force applied to it, and to how much force.

In one embodiment, the compressible layer 3120 can include an optically clear gel adhesive with a Poisson's ratio of less than approximately 0.48. For a first example, the drive-and-sense construct 3130 can be embedded in the gel adhesive. For a second example, the drive-and-sense construct 3130 can be positioned so that it is not embedded in the gel adhesive. In such examples, the drive-and-sense construct 3130 can be positioned so that it is separate from the gel adhesive, and operates independently of whether the gel adhesive is being compressed.

Force Sensitive Structures

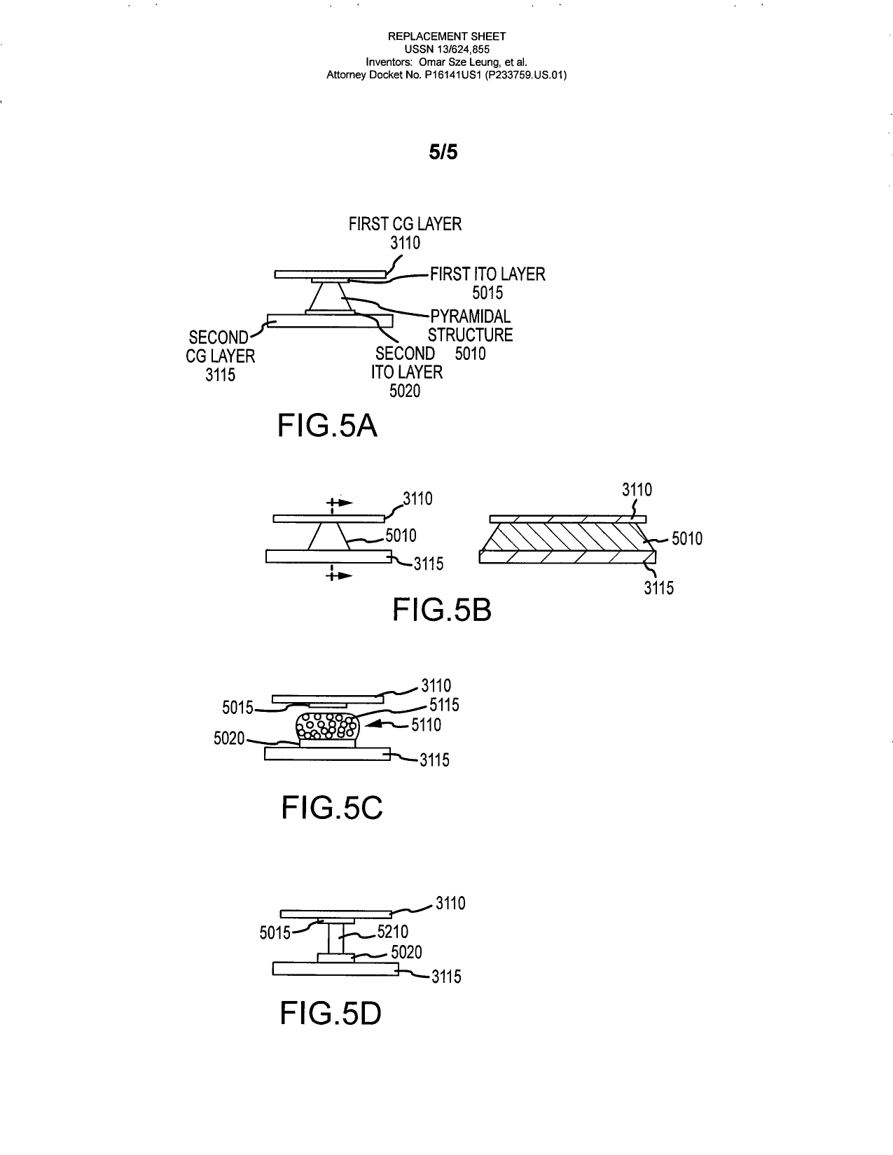

FIGS. 5A-D show conceptual drawings of force sensitive structures.

In one embodiment, the compressible layer 3120 can include a first set of force sensitive structures. The force sensitive structures can include physical elements that are compressible, in addition to or instead of gels or liquids. These force sensitive structures can include features that are themselves compressible even if the material to which they are affixed or partially embedded, if there is such a material, is not otherwise compressible. This can have the effect that when force is applied to the CG construct 3020, that force is resisted by the force sensitive structures. In response to the resistance by the force sensitive structures, the touch I/O device can determine an amount of force being applied to the CG construct 3020. Spaces between the force sensitive structures may be filled with a liquid or gel having the same or nearly the same index of refraction as the material forming the force-sensitive structures, thereby reducing or minimizing optical distortions that may otherwise occur due to mismatched indices of refraction.

In one embodiment, the force sensitive structures include compressible features relatively smaller than optical wavelengths. As described herein, this can have the effect that those compressible features can be substantially transparent, or otherwise not apparent to the user's eye when the user is applying force to the device, when the applied force is removed, or when the user is otherwise using the device.

In one embodiment, the force sensitive structures can be constructed using one or more of a set of possible construction techniques. For a first example, the structures can be constructed by etching voids into a relatively solid substance that serves as a mold substrate, such as silicon or suitable metals, to form a mold. The mold may also be made by any other suitable method, such as drilling, cutting, or otherwise mechanically removing portions of the mold substrate. This mold may be filled with a gel or other elastomeric material, one example of which is silicone, a composite material such as a nanoparticle-filled polymer, or otherwise. The material may be removed from the mold and used as a force-sensitive structure. For a second example, the structures can be constructed by growing elements from the first CG layer 3110 downward, similar to stalactites, or from the second CG layer 3115 upward, similar to stalagmites. For a third example, the structures can be constructed by an embossing or nanoimprint process, a photoresist process, or other methods.

In one embodiment, the force sensitive structures can be constructed with substantially empty space between the first CG layer 3110 and the second CG layer 3115, with the effect that the force sensitive structures absorb force applied between the first CG layer 3110 and the second CG layer 3115. In alternative embodiments, the force sensitive structures can be constructed with spaces between the elements of the force sensitive structures filled with a foam, a gel, a liquid, a springy or viscoelastic substance, a solid substance with a memory effect of returning to its original pre-deformation shape, or otherwise. For a first example, the spaces between the elements of the force sensitive structures can be filled with a nanofoam, that is, a foam with a set of nanopores, that is, nanostructure-sized holes disposed therein, with the effect that the nanofoam is capable of being compressed with a Poisson's ratio of less than about 0.48. For a second example, the spaces between the elements of the force sensitive structures can be filled with a set of micro-structured or nanostructured silicone elements, with the effect of being compressible in response to applied force, and also with the effect of returning to their original shape after the applied force is removed.

FIG. 5A shows a conceptual drawing of a set of pyramidal structures.

In one embodiment, the force sensitive structures can include a set of pyramidal rubber structures or pyramidal silicone structures (“nanostructures”) 5010, each of which can be positioned between the first CG layer 3110 and the second CG layer 3115. In the context of the invention, there are no particular requirements with respect to the sizes of the nanostructures. In a first such case, the nanostructures could be of substantially uniform size. In a second such case, the nanostructures could include nanostructures that are substantially of different sizes, such as including nanostructures of more than one size, or including nanostructures having a range of sizes. Moreover, in the context of the invention, there are no particular requirements with respect to the positioning of the nanostructures. In various possibilities, the nanostructures could be (A) positioned in a regular pattern; (B) positioned in random or pseudorandom locations; (C) positioned in some regions in one regular pattern and in other regions in a different regular pattern; (D) positioned in some regions in a regular pattern and in other regions in random or pseudorandom locations; or (E) some combination or conjunction thereof, or otherwise.

For example, pyramidal silicone structures 5010 can be positioned with the second CG layer 3115 at a bottom position. In such examples, positioned over the second CG layer 3115 can be a first ITO layer 5015, such as the drive columns 4025 for the touch sensor or the drive columns 4065 for the force sensor. In such examples, positioned over the first ITO layer 5015 can be a base of the pyramidal silicone structures 5010. In such examples, positioned over the base of the pyramidal silicone structures 5010 can be the tip of the pyramidal silicone structures 5010, which can be a truncated tip (that is, a top of a truncated pyramid) or which can be a substantially non-truncated tip. In such examples, positioned over the tip of the pyramidal silicone structures 5010 can be a second ITO layer 5020, such as the sense row 4035 for the touch sensor and the sense row 4075 for the force sensor, or such as a combined set of sense rows 4075 for the touch sensor and the force sensor. In such examples, positioned over the second ITO layer 5020 can be the first CG layer 3110.

In alternative embodiments, the pyramidal rubber structures or pyramidal silicone structures 5010 can be inverted. In such cases, the base of the pyramidal structures 5010 can be at the top and can be coupled to the first CG layer 3110, while the tip of the pyramidal structures 5010 can be at the bottom and can be coupled to the second CG layer 3115. In other and further alternative embodiments, some of the pyramidal rubber structures or pyramidal silicone structures 5010 can be right side up while others can be inverted. In such cases, some of the pyramidal structures 5010 can be coupled at the base to the first CG layer 3110 and at the tip to the second CG layer 3115, while others can be coupled at the base to the second CG layer 3115 and at the tip to the first CG layer 3110. In other and further alternative embodiments, some or all of the pyramidal structures 5010 can be disposed with pairs with two bases, one coupled to the first CG layer 3110 and one to the second CG layer 3115, with the two tips of the pair meeting in a midpoint.

In one embodiment, the pyramidal rubber structures or pyramidal silicone structures 5010 can have a stiffness substantially equal to a value d², where d can be a parameter related to a capacitance of the substance used for the pyramidal structure 5010.

FIG. 5B shows a conceptual drawing of a set of elongated pyramidal structures.

In alternative embodiments, the pyramidal structure 5010 can be constructed in an elongated manner, with a cross-section that is pyramidal in a first direction, and is linear in a second direction. This has the effect that the pyramidal structure 5010 has a triangular shape when a cross-section is viewed across the structure 5010 along that first direction, and has a linear shape or a wall shape when a cross-section is viewed across the structure 5010 along that second direction. In one embodiment, the elongated pyramidal structures 5010 can have a stiffness substantially equal to a value d, where d can be a parameter related to a capacitance of the substance used for the pyramidal structure 5010.

FIG. 5C shows a conceptual drawing of a set of “moth eye” structures.

Similarly, in one embodiment, the force sensitive structures can include a set of “moth eye” structures 5110, each of which can have a base and a substantially hemispherical or near-hemispherical shape, and each of which can include a set of compound elements 5115, similar to the structure of a moth's eye. While this application primarily describes “moth eye” structures 4110 with particular shapes and orientations, in the context of the invention, there is no particular requirement for any such limitation. For a first example, the “moth eye” structures 4110 can include compound elements 4115 that are oriented substantially perpendicular to the base film. For a second example, the “moth eye” structures 4110 can include compound elements 4115 that have a density that decreases with increasing distance from the base film, that is, the compound elements 4115 are thick or dense near the base film, and are thinner or less dense with increasing distance away from the base film.

In such embodiments, similar to the pyramidal structures 5010, the moth eye structures 5110 can be coupled to the first CG layer 3110 and a first ITO layer 5015 at a top and to the second CG layer 3115 and a second ITO layer 5020 at a base. In alternative embodiments, similar to the pyramidal structures 5010, the moth eye structures 5110 can be inverted, and can be coupled to the first CG layer 3110 and a first ITO layer 5015 at a base and to the second CG layer 3115 and a second ITO layer 5020 at a top. In other and further alternative embodiments, similar to the pyramidal structures 5010, the moth eye structures 5110 can have some inverted and others non-inverted. In other and further alternative embodiments, similar to the pyramidal structures 5010, the moth eye structures 5110 can be disposed with pairs with two bases, one coupled to the first CG layer 3110 and one to the second CG layer 3115, with the two tips of the pair meeting in a midpoint.

FIG. 5D shows a conceptual drawing of a set of cylindrical structures.

Similarly, in one embodiment, the force sensitive structures can include a set of cylindrical structures 5210, each of which can have a base and a tip, and a substantially cylindrical (or polygonal) cross-section. In such embodiments, similar to the pyramidal structures 5010, the cylindrical structures 5210 can be coupled to the first CG layer 3110 and a first ITO layer 5015 at a top and to the second CG layer 3115 and a second ITO layer 5020 at a base. In such embodiments, the cylindrical structures 5210 can include elements or substances to optimize their relative stiffness independent of a value d, where d can be a parameter related to a capacitance of the substance used for the structure. For example, cylindrical structures can have their stiffness tuned with respect to the parameter d, such as using angles, shapes, or auxiliary structures.

### Alternative Embodiments

After reading this application, those skilled in the art would recognize that techniques for obtaining information with respect to applied force and contact on a touch I/O device, and using that associated information to determine amounts and locations of applied force and contact on a touch I/O device, is responsive to, and transformative of, real-world data such as relative capacitance and compressibility received from applied force or contact by a user's finger, and provides a useful and tangible result in the service of detecting and using applied force and contact with a touch I/O device. Moreover, after reading this application, those skilled in the art would recognize that processing of applied force and contact sensor information by a computing device includes substantial computer control and programming, involves substantial records of applied force and contact sensor information, and involves interaction with applied force and contact sensor hardware and optionally a user interface for use of applied force and contact sensor information.

Certain aspects of the embodiments described in the present disclosure may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

We claim:

1. Apparatus including
a touch device including one or more applied force sensors, said applied force sensors including
a first cover glass element;
a second cover glass element;
a compressible layer positioned between said first and second cover glass element, said compressible layer including one or more capacitive sensors;
wherein said touch device is responsive to said capacitive sensors, and capable of determining an amount of applied force and a location of touch on a surface of said touch device.

2. Apparatus as in claim 1, wherein
said compressible layer includes a compressible structure, said compressible structure being substantially solid and having compressible elements, said compressible elements being substantially smaller than an optical wavelength.

3. Apparatus as in claim 1, wherein
said compressible layer includes a compressible structure, said compressible structure being substantially solid and having compressible elements, said compressible elements having a compression resistance substantially linear in compression with respect to a compression parameter.

4. Apparatus as in claim 1, wherein
said compressible layer includes a compressible structure, said compressible structure being substantially solid and having compressible elements, said compressible elements having a compression resistance substantially polynomial in compression with respect to a compression parameter.

5. Apparatus as in claim 1, wherein
said compressible layer includes one or more of:
a solid compressible element, said solid compressible element including one or more of:
a cylindrical elastomer element, a moth eye element, a nanopore element, a pyramidal elastomer element.

6. Apparatus as in claim 1, wherein
said compressible layer includes separate applied force sensors and touch sensors.

7. Apparatus as in claim 1, wherein
said capacitive sensors include
a first transparent conductive electrode layer including an element capable of coupling a drive signal to said capacitive sensors, and
a second transparent conductive electrode layer including an element capable of coupling a sense signal from said capacitive sensors.

8. Apparatus as in claim 7, wherein
responsive to a deformation of said first cover glass layer, said first and second transparent conductive electrode layer provide a signal indicative of applied force.

9. Apparatus as in claim 7, wherein
responsive to a deformation of said first cover glass layer, said first and second transparent conductive electrode layer provide a signal indicative of touch.

10. Apparatus as in claim 1, wherein
said compressible layer includes one or more of:
a foam, a gel, a liquid, an optically translucent or transparent substance.

11. Apparatus as in claim 10, wherein
said compressible layer includes a substance having a Poisson's ratio of less than approximately 0.48.

12. A touch device including
a cover glass element, said cover glass element being substantially flexible;
a force sensor, said force sensor including
a substantially rigid element disposed below said cover glass element;
a compressible layer positioned between said cover glass element and said substantially rigid element, said compressible layer including one or more elements disposed to detect a measure of compression of said compressible layer;
wherein said force sensor is capable of determining an amount and a location of applied force in response to said measure of compression.

13. Apparatus as in claim 12, wherein
said compressible layer includes one or more elements having a first size characteristic and one or more elements having a second size characteristic, said first size characteristic being distinct from said second size characteristic.

14. Apparatus as in claim 12, wherein
said compressible layer includes one or more elements having a substantially uniform size.

15. Apparatus as in claim 12, wherein
said compressible layer includes one or more elements positioned substantially in a random or pseudorandom pattern.

16. Apparatus as in claim 12, wherein
said compressible layer includes one or more elements positioned substantially in a regular pattern.

17. Apparatus as in claim 12, wherein
said compressible layer includes one or more elements positioned substantially in a regular pattern, and one or more elements positioned substantially in a random or pseudorandom pattern.

18. Apparatus as in claim 12, wherein
said compressible layer includes one or more first regions having elements positioned substantially in a regular pattern, and one or more second regions having elements positioned substantially in a random or pseudorandom pattern;
said first regions and said second regions being coupled in a network thereof.

19. Apparatus as in claim 12, wherein
said compressible layer includes one or more nanostructures disposed at a substantial angle with respect to a base layer, said base layer being at least one of: said first cover glass element, said second cover glass element.

20. Apparatus as in claim 12, wherein
said compressible layer includes one or more nanostructures having a density gradient with respect to a base layer.

21. Apparatus as in claim 12, wherein
said compressible layer includes one or more nanostructures having a first density value with respect to a distance from a base layer, and a second density value with respect to said base layer.

22. Apparatus as in claim 12, wherein
said compressible layer includes one or more substantially open elements and one or more substantially compressible solid elements.

23. Apparatus as in claim 12, wherein
said compressible layer includes one or more substantially open elements and one or more substantially compressible solid elements;
said substantially open elements and said substantially compressible solid elements being coupled in a network thereof.

24. A touch device as in claim 12, wherein
said force sensor is responsive to a measure of deformation of said cover glass element.

25. A touch device as in claim 12, wherein
said force sensor is responsive to a measure of distance between said cover glass element and said substantially rigid element.

26. Apparatus as in claim 12, wherein
said compressible layer includes a compressible structure, said compressible structure having compressible elements that are substantially smaller than an optical wavelength.

27. Apparatus as in claim 26, wherein
said compressible elements have a compression resistance substantially nonlinear in compression with respect to a compression parameter.

28. A touch device as in claim 12, wherein
said elements disposed to detect a measure of compression include one or more capacitive sensors.

29. Apparatus as in claim 28, wherein
said capacitive sensors include
a first transparent conductive electrode layer including an element capable of coupling a drive signal to said capacitive sensors, and
a second transparent conductive electrode layer including an element capable of coupling a sense signal from said capacitive sensors.

30. Apparatus as in claim 12, wherein
said compressible layer includes one or more touch sensors.

31. Apparatus as in claim 30, wherein
said touch sensors include
a first transparent conductive electrode layer including an element capable of coupling a drive signal to said capacitive sensors, and
a second transparent conductive electrode layer including an element capable of coupling a sense signal from said capacitive sensors.

32. A method, including steps of
measuring an amount of applied force and a location of touch for a contact applied to a surface of a touch device, said steps of measuring including
disposing a compressible layer between a first cover glass element and a second cover glass element in said touch device;
sensing a measure of distance between elements coupled to said first cover glass element and said second cover glass element;
wherein said measure of distance is responsive to a deformation of at least one of: said first cover glass element, said second cover glass element.

33. A method as in claim 32, wherein
said steps of measuring an amount of applied force and a location of touch include steps of
measuring an applied force to said compressible layer in response to a deformation of at least one of: said first cover glass element, said second cover glass element;
measuring a location of touch in response to a capacitance with at least one of: said first cover glass element, said second cover glass element.
wherein said steps of measuring applied force and measuring location of touch are substantially concurrent.

34. A method as in claim 32, wherein
said steps of sensing a measure of distance include
coupling a drive signal to a first conductive layer, and
reading a sense signal from a second conductive layer.

35. A method as in claim 32, wherein
said steps of sensing a measure of distance are responsive to a measure of capacitance between said first cover glass element and said second cover glass element.

36. A method of operating a touch device, including steps of
measuring an amount of applied force and a location of touch for a contact applied to a surface of a touch device, said steps of measuring including
disposing a substantially flexible layer at a surface of said touch device;
disposing a substantially rigid layer below said substantially flexible layer; and
sensing a measure of deformation of said substantially flexible layer with respect to said substantially rigid layer;
wherein said steps of sensing a measure of deformation are responsive to a compressible layer disposed between said substantially flexible layer and said substantially rigid layer.

37. A touch device as in claim 36, wherein
said steps of measuring an amount of applied force and location of touch include steps of
measuring a distance between said cover glass element and said substantially rigid element.

38. A touch device as in claim 36, wherein
said steps of sensing a measure of deformation include measuring an amount of capacitance between said substantially flexible layer and said substantially rigid layer.

39. A method as in claim 36, wherein
said steps of measuring an amount of applied force and location of touch include steps of
measuring a compression resistance of a compressible layer between said substantially flexible layer and said substantially rigid layer.

40. A method as in claim 39, wherein said compression resistance is substantially nonlinear in compression with respect to a compression parameter.
